(19) United States
(12) Patent Application Publication
(10) Pub. No.: US 2010/0169122 A1
(43) Pub. Date: Jul. 1, 2010

(54) IDENTIFICATION OF HEALTH CARE ASSOCIATED INFECTIONS

(75) Inventors: CHAD BARRETT RUOFF, Lee's Summit, MO (US); MICHAEL DEAN SCHMITT, Kansas City, MO (US); SUSAN TARKKA, Kansas City, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/347,575

(22) Filed: Dec. 31, 2008

(51) Int. Cl. G06Q 50/00; G06Q 90/00

(52) U.S. Cl. 705/3

(57) ABSTRACT

Described herein are embodiments directed to displaying presumptive health care infections (HAIs) that may be affecting a patients in health care facilities. Patient data is stored in a database. Software-encoded health care rules for detecting HAIs infections are applied to the patient data and used to classify a patient as having an HAI or community-acquired illness. If an HAI infection is detected, an indication of the HAI is communicated to a remote computer for display in a graphical user interface (GUI) to a clinician. Lists of patients at a given health care facility are communicated to the clinician and organized into groups of patients with HAIs and community-acquired infections.

### BACKGROUND

In hospitals and other health care facilities, patients may be exposed to various health care associated infections (HAI), otherwise known as nosocomial infections. HAIs are infections that are a result of treatment in a hospital or health care facility, but are secondary to a patient's original condition. For example, a patient admitted to a hospital for a broken leg may contract influenza from a treating nurse who has the virus. HAIs typically appear within seventy-two hours after a patient is admitted or within thirty days after a patient is discharged. Common HAIs include, without limitation, staff infections, tuberculosis, pneumonia, urinary tract infections, influenza, and any virtually contractible infections.

HAIs are common in hospitals and health care facilities for a number of reasons. These facilities house numerous people who are sick and, as a result, have weakened immune systems impairing their defense against bacteria. For instance, advanced age, premature birth, and immunodeficiency make patients more susceptible to infections. Moreover, medical staff and instrumentation move from patient to patient, providing an easy path for pathogens to spread. Further, numerous medical procedures use invasive devices (such as intubation tubes, catheters, surgical drains, and tracheostomy tubes), which bypass a body's natural lines of defense against pathogens. Further still, routine use of antimicrobial agents in hospitals creates selection pressure for the emergence of resistant infectious strains.

### SUMMARY

One aspect of the invention relates to determining and displaying determining whether patients have HAIs. Patient data is received and software-based rules are applied thereto to determine whether the patient is affected by an HAI or a community-acquired infection. Indications about whether the user has an HAI are stored and can be placed within a document for transmission to a remote computing device. The document identifies which patients presumptively have HAIs and which have community-acquired illnesses.

Another aspect relates to remote computing devices configured to query servers for lists of patients containing HAIs. In this aspect, the servers are configured to apply software-based rules to patient data to determine whether patients have HAIs or community-acquired illnesses. The eventual classification of HAI or community-acquired illness may ultimately lie with an overseeing clinician; however, presumptive determinations may be made by the servers and transmitted to the remote computers.

### BRIEF DESCRIPTION OF THE SEVERAL VIEWS OF THE DRAWINGS

The present invention is described in detail below with reference to the attached drawing figures, wherein:

FIG. 1 is a block diagram illustrating components of a system for use, according to an embodiment of the present invention;

FIG. 2 is a flow diagram illustrating a method in a computerized health care environment for determining and displaying presumptive HAIs, according to an embodiment of the present invention;

FIG. 3 is an illustrative graphical user interface displaying an interactive screen for documenting surveillance after a presumptive HAI has been determined, according to an embodiment of the present invention;

FIG. 4 is an illustrative graphical user interface displaying an interactive screen for documenting whether a patient suffers from a presumptive HAI, according to an embodiment of the present invention;

FIG. 5 is an illustrative graphical user interface displaying an interactive screen for documenting whether a patient suffers from a presumptive HAI, according to an embodiment of the present invention; and

FIG. 6 is an illustrative graphical user interface displaying an interactive screen displaying patients with a presumptive HAI or needing further evaluation, according to an embodiment of the present invention.

### DETAILED DESCRIPTION

The subject matter described herein is presented with specificity to meet statutory requirements. The description herein, however, is not intended to limit the scope of this patent. Instead, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

To date, HAIs are detected using laboratory or time-based criteria for marking infections. Detection requires accessing disconnected databases or utilizing niche data-mining techniques that are not integrated with overall patient care processes or electronic medical records. Using disjointed computer resources makes it difficult to efficiently recognize HAIs in a seamless manner, because the resources may not be configured to properly communicate with each other.

In addition, the investigation, designation, and classification of HAIs continue to be a labor-intensive, manual process. A clinician usually has to perform a procedure (e.g., a rapid test, Chem 20 laboratory test, etc.) to determine whether a patient has an HAI. The clinician must make a judgment as to what test to perform. And if that judgment is incorrect, the patient's HAI may not be diagnosed. Furthermore, to make such a judgment, the clinician may have to access numerous databases for the patient's medical history. If the correct database cannot be accessed, the clinician must decide what strategy to pursue based on limited knowledge.

In general, embodiments described herein are directed to automatically identifying presumptive HAIs and presenting such an identification to a health care provider. In one embodiment, patient data generated from various health care venues are analyzed in order to presumptively identify an HAI. A central database storing community health care data may be used to refine diagnostic rules that are encoded in software and applied to the patient data. Once determined, the presumptive HAI may be communicated to the clinician who is interacting with a patient's medical records or may be stored in a central database of patient records. The final diagnosis of the HAI may ultimately lie with the clinician, who may consult additional resources; however, in one embodiment, the classification of a patient's illness as an HAI is determined electronically by software and displayed to the clinician on a computing device.

Determining which infections are community acquired (i.e., obtained outside of a health care facility) and which infections are HAIs is particularly important to insurance companies providing health care. These companies will often refuse to pay for treatment of HAIs, because these infections are caused by the health care facilities themselves.

Embodiments described herein routinely refer to a clinician or health care practitioner. Clinicians and practitioners may include, for example, doctors, nurses, technicians, infection control practitioners (ICPs), or other health care providers. It will be evident to one skilled in the art that numerous health care personnel may qualify as a clinician or practitioner, as described herein.

To determine whether an infection, ailment, or other disorder is either an HAI or “community acquired,” rules, implemented in software, weigh various types of data about a patient. The rules may take into account patient-specific data, patient-location data, treating-clinician data, or the like. Patient-specific data may include a patient's health care and personal information. For example, without limitation, the patient's health care and personal information may include indications of age, date of birth, gender, ethnicity, blood type, allergies, clinician orders, surgeries, medical histories, surgical histories, medical tests, results of medical tests, patient symptoms, addictions, diseases, viruses, evaluations of medical imaging. As one skilled in the art will understand, medical imaging may include various testing techniques capable of analyzing the patient's body as well as its function. Examples include, without limitation, X-Ray, magnetic resonance imaging (MRI), multimodal neuroimaging, anatomically constrained magnetoencephalography (aMEG), nuclear magnetic resonance (NMR), electroencephalogram (EEG), electrocardiogram (EKG), and ballistocardiogram.

Patient-location data refers to information about health care facilities, attending medical staff (including clinicians), and other patients. Examples include, without limitation, indications of recent outbreaks in a patient's hospital, room, or wing, as well as patient and clinician histories in health care rooms (e.g., the type of surgery previously performed in a surgery room). Patient-location data may also refer to the particular area of a hospital, such as an emergency room or burn center, where infections may spread more rapidly.

Treating-clinician data refers to information about the health of treating clinicians. For example, if a treating clinician recently took several sick days off from work, or if a clinician had recently treated someone with tuberculosis. One skilled in the art will understand that various information may qualify as patient-specific, patient-location, and treating-clinician data. In operation, patient-specific, patient-location, and treating-clinician data may be stored in one or more databases—such as, for example, in database cluster 24 described below.

In one embodiment, indications of HAI determinations are presented within an electronic document on a computing device. The document may be any kind of well-known document, such as a document coded in a markup language. Examples of markup languages include, without limitation, hypertext markup language (HTML), extensible markup language (XML), extensible hypertext markup language (XHTML), or the like.

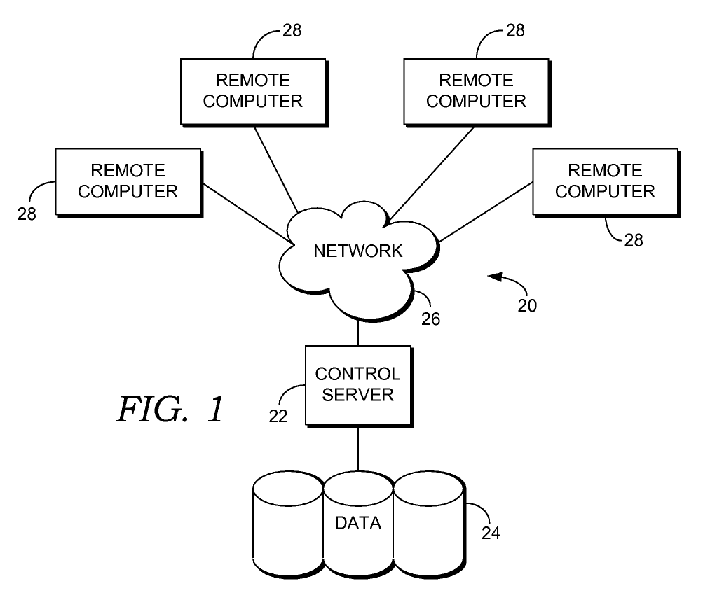

With reference to FIG. 1, an exemplary medical information system for implementing embodiments of the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus (also known as a Mezzanine bus).

Server 22 typically includes therein or has access to a variety of computer-readable media, for instance, database cluster 24. Computer-readable media can be any available media that can be accessed by server 22, and includes both volatile and nonvolatile media, removable and nonremovable media. By way of example, and not limitation, computer-readable media includes computer-storage media. Computer-storage media includes volatile and nonvolatile, removable and nonremovable media implemented in any method or technology for storage of information, such as computer-readable instructions, data structures, program modules or other data. Computer-storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22.

The computer-storage media, including database cluster 24, discussed above and illustrated in FIG. 1, provides storage of computer-readable instructions, data structures, program modules, and other data for server 22. Server 22 may operate in a computer network 26 using logical connections to one or more remote computers 28. Each remote computer 28 may be any well-known computing devices, such as, for example but without limitation, a computer, palm pilot, personal digital assistant (PDA), smartphone, BlackBerry®, or the like. Furthermore, remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians include, but are not limited to, the treating physician; specialists such as surgeons, radiologists and cardiologists; emergency medical technologists; discharge planners; care planners; physician's assistants; nurse practitioners; nurses; nurse's aides; pharmacists; dieticians; microbiologists; laboratory experts; laboratory scientists; laboratory technologists; genetic counselors; researchers; veterinarians; and the like.

The remote computers may also be physically located in nontraditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise wide computer networks, intranets and the Internet. When utilized in a WAN networking environment, server 22 may include a modem or other means for establishing communications over the WAN, such as the Internet.

In a networked environment, program modules or portions thereof may be stored in server 22 or database cluster 24 or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention. Although the method and system are described as being implemented in a LAN operating system, one skilled in the art would recognize that the method and system can be implemented in any system.

In one embodiment, database cluster 24 is configured to store patient data. The lists of different types of patient data provided above are merely exemplary and are not meant to be exhaustive. Also, techniques for storing, organizing, and retrieving patient data in database cluster 24 are well-known to those skilled in the art, and need not be discussed at length herein.

In one embodiment, patient data may include an order, such as a request by a clinician for an action related to the patient. The action can be the initiation of a diagnostic test, the administration of a medication, a defined diet, or other health care-related action. Orders are captured by clinical information systems by a variety of means—direct user entry (computerized provider order entry (CPOE)), indirect entry by an intermediary, for example a verbal or written request that is conveyed to a nurse, the lab or pharmacy; or by an interface from another information system.

Orders can be placed singly or as a set. A single order would be ordering an individual medication or a serology test, while a set has multiple orders. An exemplary order set is a Chem 20, in which a number of discrete laboratory tests are ordered through a single action. Placing an order in the system has a variety of implications, including its formal presence in the clinical workflow and the triggering of billing-related events.

In one embodiment of the invention, an order within a set of orders can be designated as optional. Unlike conventional orders, optional orders are not placed in the system by default when the set of orders is placed. An optional order can be activated at the time the order set is placed or later in the process. If the user is ordering a set of orders associated with optional orders, the user is prompted to activate the optional orders. Optional orders that are selected are activated and added to the set of orders. Optional orders that were not activated when ordering the order set are displayed with the set of placed orders, allowing them to be activated later if necessary. A technologist or scientist can activate optional orders based on the findings associated with other orders in the case, allowing for flexibility of the testing path. In another embodiment, the ability to designate whether the activation of the order can occur at order time or only after the order sets have been placed is provided.

Although many other internal components of server 22, database cluster 24, and computers 28 are not shown, those of ordinary skill in the art will appreciate that such components and their interconnection are well known. Accordingly, additional details concerning the internal construction of server 22 and computer 28 need not be disclosed in connection with the present invention.

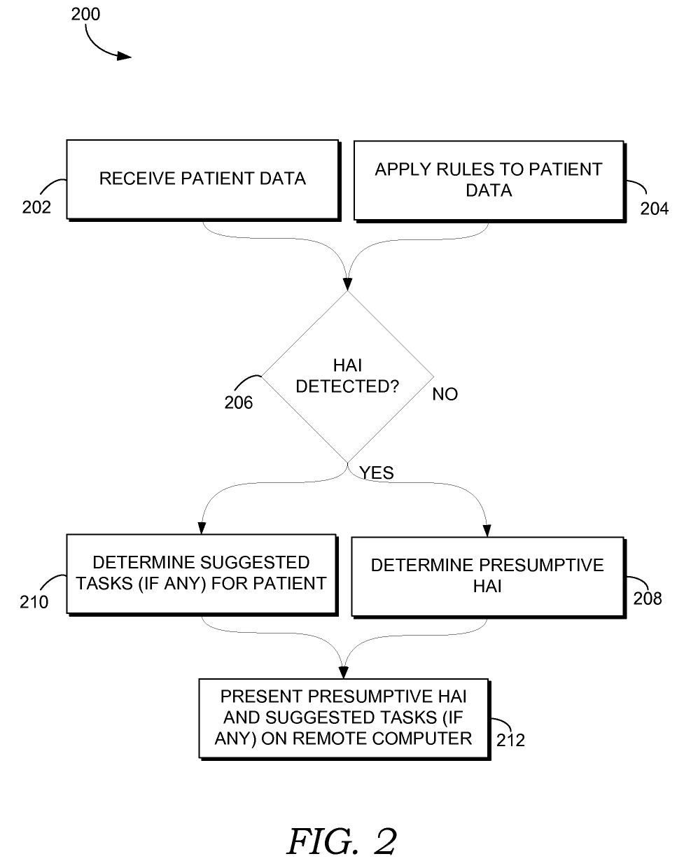

With reference to FIG. 2, a method 200 in a computerized health care environment for determining and presenting presumptive HAIs, according to an embodiment of the present invention, is shown. At step 202, patient data is received by a server and stored, in one embodiment, in a database. For example, information about a patient's recent surgery as well as an attending nurse's history with an infection may be received by server 22 and stored in database cluster 24.

As indicated at step 204, rules are applied to stored patient data so that presumptive HAIs can be detected. In one embodiment, rules refer to medical knowledge, principles, and theories that are coded in software and configured to run automatically using various well-known coding techniques (e.g., interrupts, loops, etc.). One example of a rule would be indicating a patient has been infected with Helicobacter pylori when the patient complains of stomach pains and a rapid urease test revealed a prominent concentration of ammonia. In another example, a patient who is forty hours out of open-heart surgery and has been in the hospital for seventy-two hours develops a sternal wound showing signs of infection. If the wound is cultured and results are positive for Staphylococcus aureus, a rule may be configured to determine a presumptive HAI of a staff infection based on the results of the culture, the type of surgery, and the time elapsed from surgery to the recognition of symptoms.

In another example, a patient who has recently had a child, has currently been vomiting, and was attended to by a nurse who has contracted influenza, may trigger a rule that indicates the patient has an HAI. In yet another example, a rule may take into account the health of a patient previously scanned in an x-ray room. If the previous patient was diagnosed with an infectious illness, the rule may raise the likelihood that the current patient contracted the same illness from the x-ray room. Or in still another example, rule may take into account the health of a physician (or other clinician) coming from an unit of the health care facility that has more exposure to infectious illnesses—such as an intensive-care, emergency, or burn unit. Thus, the rules may account for infections and illnesses that are transmitted throughout the health care facility by clinicians or rooms in the facility.

As one skilled in the art will understand, a rule may comprise virtually any combination of medical knowledge in conjunction with a patient's data. Embodiments are not limited to any particular rules, as many medical decisions may be encoded as a result of various symptoms.

Once an HAI is detected, suggested tasks may then be determined by a server (e.g., server 22), as indicated at step 208. These tasks may include a myriad of tests, medications, health plans, or other medical strategies to either confirm the HAI or help treat it. For example, a triple-therapy of amoxicillin, clarithromycin, and a proton pump inhibitor (e.g., omeprazole or metronidazole) may be suggested when Helicobacter pylori is detected. Or, in another example, acetaminophen may be suggested to relieve the aches and pains of a patient with influenza. Embodiments are not limited to any particular task, as numerous medical strategies, medications, and techniques may be suggested based on the type of HAI detected as well as the orders associated with a patient. Moreover, some embodiments may not suggest tasks at all—as indicated by the OPTIONAL identifier in step 208. In such embodiments, only detected HAIs are passed on to a clinician.

Once presumptive HAIs are detected and suggested tasks, if applicable, are determined, both may be presented on a remote computer (e.g., remote computer 28) to a clinician, as indicated at step 212. In one embodiment, determined HAIs are indicated in an HTML document as a category for a list of patients. For instance, multiple patients may be listed in the HTML list, along with various information about each patient-such as, patient name, attending clinician, bed, nurse unit, admit data, length of stay, clinical indicator (i.e., type of ailment), risk of HAI infection, whether the patient should be isolated, and why the patient should be isolated (e.g., airborne precautions, contact precautions, etc.).

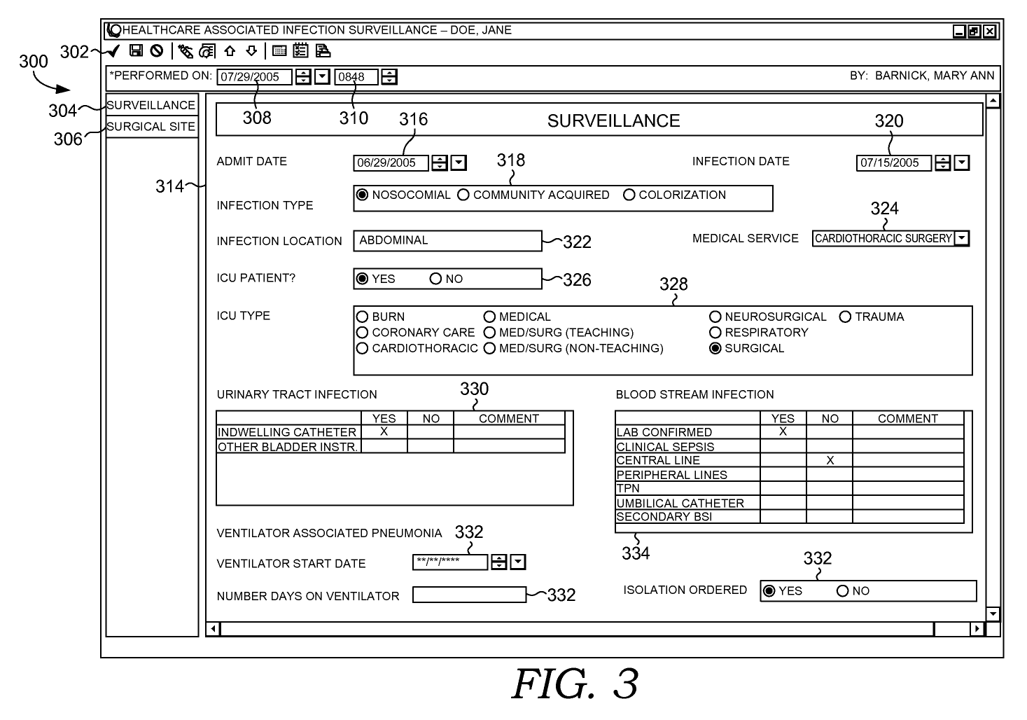

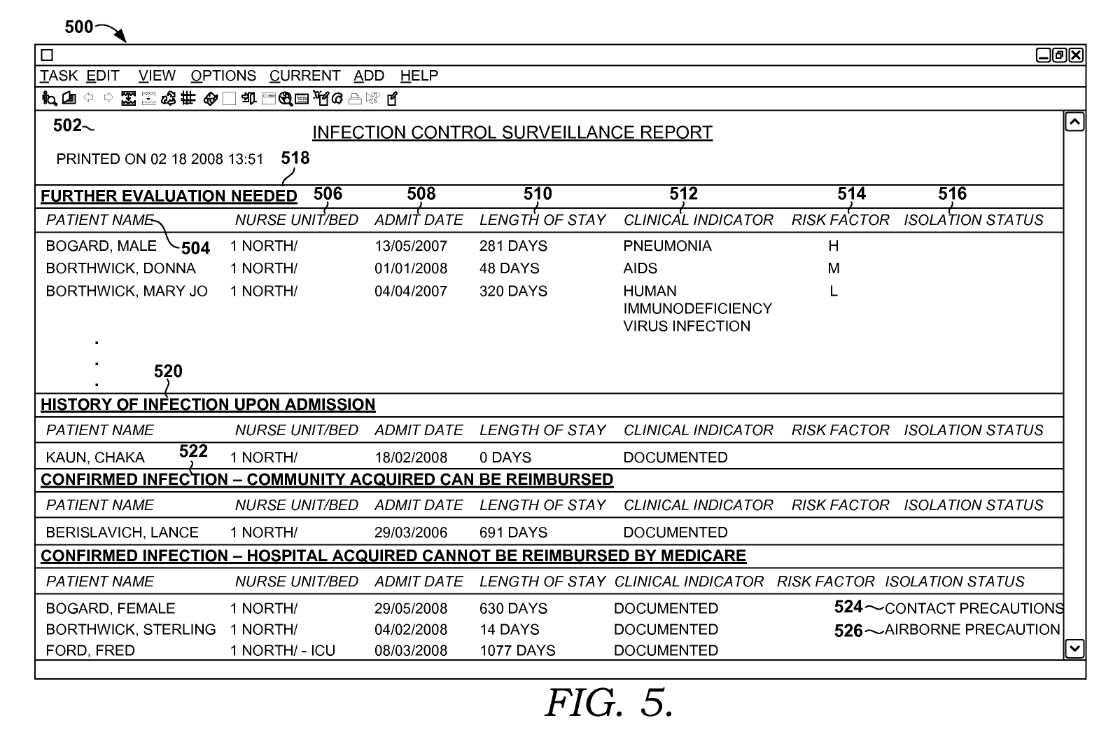

This patient information may be displayed in an interactive graphical user interface (GUI)—e.g., the GUIs illustrated in FIGS. 3-6. Additionally, the list of patients may be grouped into groups of patients with community-acquired infections and groups of patients with HAIs. The document may be interactive, allowing a clinician to drill down on any specific patient by hyperlinking entries to a another document detailing each the reasons a given HAI or community-acquired determination was made. For example, a clinician could click on a listed patient and, as a result, be directed to a page detailing the reasons an HAI was presumptively determined. This option is shown more clearly in FIG. 5 below.

Turning now to FIG. 3, an illustrative GUI 300 displaying an interactive screen for documenting surveillance after a presumptive HAI has been determined, according to an embodiment of the present invention is shown. GUI 300 may be shown after a presumptive HAI has been determined and presented to a clinician. In reality, GUI 300 may be used to collect additional patient data after the presumptive HAI has been identified. For example, if a patient complains of stomach pains and server 22 suggests the patient is suffering from influenza, GUI 300 may be used to collect additional data thereafter in order for the clinician to make an educated prognosis.

In one embodiment, GUI 300 includes various tools and parameters for the clinician. A toolbar 302 may provide various GUI controls, such as, saving, filing, or printing. In the left-hand portion of GUI 300 is a list of tabs that allow the clinician to quickly access multiple screens relating to specific medical categories. For example, one tab may be a surveillance tab 304 (shown) that indicates the symptoms or tests performed on the patient. Or a surgical site tab 306 (not shown) that describes the general condition and maintenance of the patient's place of surgery may be presented. Additionally, dates 308 and times 310 may be entered for various medical procedures, analyses, or other patient data related to a patient. One skilled in the art will appreciate that other controls, tabs, or options may easily be added to GUI 300, and embodiments are not limited to any of the particulars illustrated therein.

Surveillance screen 314 is illustrated as an example of an interactive screen that may be displayed to the clinician in order to enter patient data about the patient. Such a screen may be advantageous to view either before or after a presumptive HAI is determined. The patient's date of admission may be inputted into a text field 316. An indication of the type of infection currently associated with the patient, or presumed to be associated with the patient, may be displayed in pick window 318. This indication may be blank in certain instances where no diagnosis or presumptive HAIs have been determined. The patient's infection location as well as the medical service required may be entered in windows 322 and 324. Whether or not the patient is in a health care facility's intensive-care unit (ICU) and the type of ICU patient the patient is may be indicated in windows 326 and 328, respectively. Furthermore, the types of infections already detected in the patient as well as treatments or patient data for each can be entered, as shown by windows 330 and 334 (e.g., a urinary tract infection 330 and blood stream infection 334). Additionally, other relevant surveillance orders (e.g., the duration of time a patient is on a ventilator or is isolated) may also be added to surveillance screen 314, as embodiments are not limited to any of the particulars illustrated in FIG. 3.

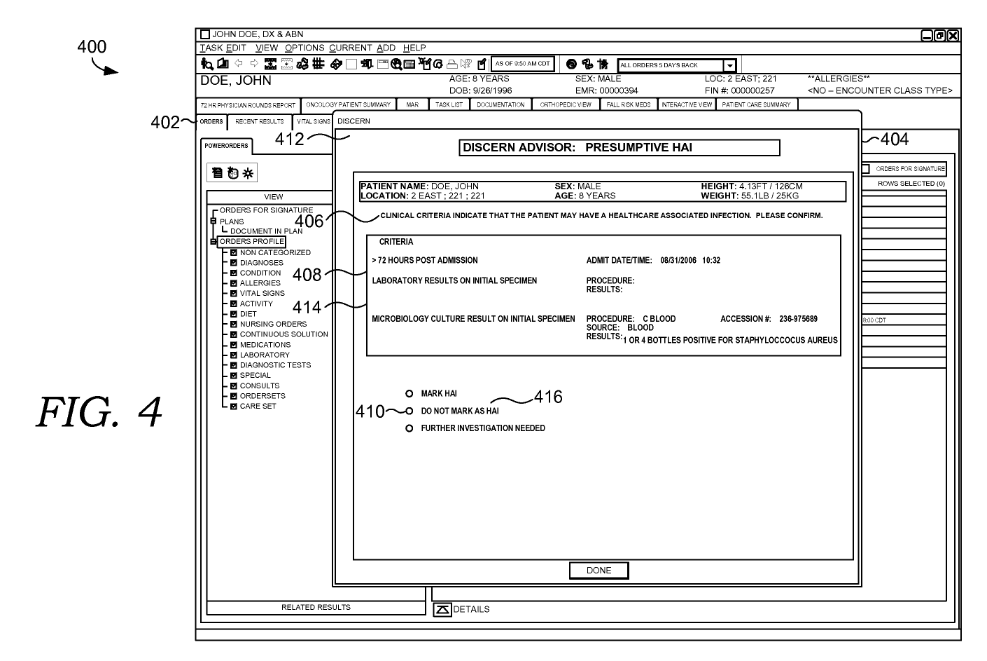

FIG. 4 is an illustrative GUI 400 displaying an interactive screen for documenting whether a patient suffers from a presumptive HAI, according to an embodiment of the present invention. GUI 400 may be presented to a clinician whenever a presumptive HAI is determined (e.g., by server 22). As illustrated in FIG. 4, the patient's name, age, date of birth (DOB), sex, location, allergies, or other patient information may be displayed underneath the controls of GUI 400.

The clinician can navigate through various tabs 402 to view different types of patient information. The tabs 402 may include, for example but without limitation, 72-hour physician-rounds reports, oncology patient summaries, MAR, task lists, orthopedic views, fall risk medications, interactive views, patient-care summaries, orders, test results, vital signs, or other well known categories. For each tab 402, a corresponding screen 404 may be presented to the clinician.

In one embodiment, a presumptive-HAI screen 404 is automatically presented to the user when a presumptive HAI is determined. Such a screen is illustrated in FIG. 4 with the title DISCERN, indicating a need for the clinician to determine whether a presumptive HAI applies to the patient. The presumptive-HAI screen 404 may include any of the aforementioned patient criteria (i.e., patient-specific, patient-location, and treating-clinician data) as well as a statement 406 that states a patient may have an HAI. The various criteria 408 used by the server 22 to determine a presumptive HAI may also be displayed. In addition, an input method, such as the pick menu 410, may be presented to the clinician to confirm whether a presumptive HAI applies to the patient.

More specifically, FIG. 4 illustrates a GUI with the following interactive display areas: notification area 412, criteria area 414, and confirmation input area 416. In one embodiment, notification area 412 provides a label of whether a particular patient (John Doe in FIG. 4) has been determined to have a presumptive HAI or a community-acquired illness. As previously mentioned, such a determination may be made by software-based rules applied to patient data. The criteria area 414 lists various criteria (i.e., patient data) used to justify the determination of presumptive HAI or community-acquired illness. Additional patient-specific, patient-location, and treating-clinician data may also be displayed in the criteria area 414. The confirmation input area 416 provides options for a clinician to classify the patient as having an HAI, having a community-acquired illness, or needing further evaluation.

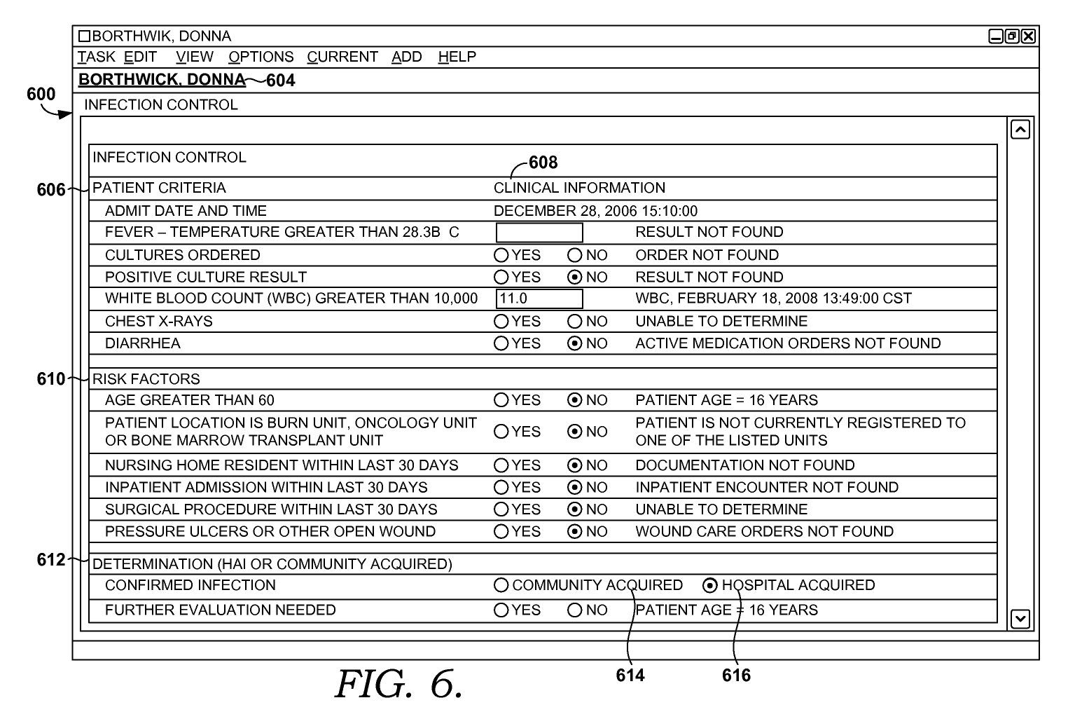

FIG. 5 illustrates an alternative GUI 500 for documenting whether a patient suffers from a presumptive HAI, according to an embodiment of the present invention. An HTML-based infection control surveillance report 502 for the patients treated at a health care facility is displayed in GUI 500. The report displays hyperlinks of patient names 504. A clinician viewing the report can obtain more specific information about each patient by simply clicking on the hyperlinked patient names 504, discussed in more detail below in reference to FIG. 6. For each listed patient, the patient's nurse unitibed 506, admit date 508, length of stay 510, clinical indicator 512, risk factor 514, and isolation status 516 is also displayed. Specifically, isolation status 516 refers to whether a patient should be isolated and/or the reason for the isolation—e.g., the patient should be isolated from areas at of infections from contact with other patients or clinicians (indicated as CONTACT PRECAUTIONS 524) or areas at risk of airborne infection (indicated as AIRBORNE PRECAUTIONS 524). Neither the above list or displayed categories are meant to be exhaustive, as other embodiments may display different patient-specific, patient-location, and treating-clinician data.

The infection control surveillance report 502 also allows the clinician to group patients into lists of those who need further examination (518), have a history of infection upon admission (520), have been determined to have a community-acquired illness (522), or have been determined to have an HAI (524). Additional groupings are also possible.

GUI 500 also shows multiple interactive display areas. Notification areas (illustrated as labels 518, 520, and 522) indicate which patients have presumptive HAIs, community-acquired illnesses, or need further evaluation. Also, when a clinician selects a hyperlinked patient name, an additional GUI (GUI 600 referred to below) that includes a criteria display area listing a selected patient's various criteria that were used by the software rules to determine what kind of illness the patient has.

If a clinician selects one of the hyperlinked patient names 504, a patient-specific document like the one illustrated in FIG. 6 is retrieved. FIG. 6 illustrates a document 600 detailing various patient-specific data (labeled Patient Criteria 606) and factors that were used by software-implemented rules to determine that a patient had either an HAI or community-acquired infection. Risk Factors 610 indicate reasons why a determination of an HAI or community-acquired illness was made. Numerous factors may be considered and listed as Risk Factors 610, as one skilled in the art will appreciate.

The document 600 also lists a determination 612 (indicated by toggle buttons 614 and 616) that was made. These toggle buttons may be manipulated, in some embodiments, by a clinician. Additionally, the determination 612 may also indicate whether a clinician or the software-based rules determine that additional evaluation is needed on a patient to identify whether the patient has an HAI.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims.

The invention claimed is:

1. One or more computer-storage media having computer-executable instructions embedded thereon for performing steps to determine and store notification of health care associated infections (HAIs) associated with a patient, comprising:
applying one or more rules to patient data, wherein the one or more rules are configured to analyze patient-specific data and determine whether the patient has an HAI;
determining the patient has an HAI; and
storing an indication that the patient has the HAI.

2. The media of claim 1, further comprising creating a document that lists a plurality of patients at a health care facility, wherein the list includes information about the patient and identifies the patient as having the HAI.

3. The media of claim 2, wherein the list includes patient identifications that comprise at least one of the of the patient's bed, nurse unit, admit date, and length of stay.

4. The media of claim 3, wherein the patient identification comprise an indication of an isolation status associated with the patient.

5. The media of claim 2, further comprising:
querying a server to determine whether each of the plurality of patients has additional HAIs;
presenting, in the document, indications of additional HAIs affecting the plurality of patients; and
identifying groups of the plurality of patients that have HAIs and groups of the plurality of patients that have community-acquired illnesses.

6. The media of claim 2, wherein the document is an HTML document.

7. The media of claim 2, wherein the document is an XML document.

8. The media of claim 1, further comprising:
creating a document that lists a plurality of patients receiving treatment at a health care facility;
identifying which of the patients have been identified as having HAIs;
identifying which of the patients have been identified as having community-acquired illnesses; and
providing hyperlinks on entries associated with the patients, wherein the hyperlinks, when selected, initiate GUIs that present one or more risk factors used to determine whether a particular patient has a particular HAI.

9. The media of claim 1, wherein the patient data includes patient-specific data.

10. The media of claim 1, wherein the patient data includes at least one of patient-location data and treating-clinician data.

11. The media of claim 1, wherein the patient data includes treating-clinician data.

12. A method for determining and displaying notification of health care associated infections (HAIs) associated with a patient, comprising:
receiving patient data about the patient;
applying software-based rules to the patient data to determine whether the patient is affected by an HAI or a community-acquired infection;
storing an indication that the user has an HAI; and
transmitting a document to a remote computing device, wherein the document identifies the patient as having the HAI.

13. The method of claim 12, wherein the document lists a plurality of patients being treated at a health care facility.

14. The method of claim 13, wherein entries for each of the plurality of patients are hyperlinked to additional documents that explain the reasons the patient was identified as having the HAI.

15. The method of claim 14, wherein each of the additional documents lists patient criteria and risk factors specific to specific patients.

16. The method of claim 12, wherein the document comprises at least one of an HTML or XML document.

17. A system for determining and displaying notification of health care associated infections (HAIs) associated with a patient, comprising:
one or more remote computers configured to transmit patient data and submit a query about the patient, wherein the query requests an identification of whether the patient has an HAI or a community-acquired illness; and
one or more servers configured to:
(1) receive the query,
(2) determine whether the patient has likely been affected by at least one HAI, and
(3) transmit a document to the one or more remote computers that identifies the patient as having the HAI.

18. The system of claim 17, wherein the document lists a plurality of patients and whether each patient has HAIs.

19. The system of claim 18, wherein the document identifies which of the plurality of patients have HAIs and which have community-acquired infections.

20. The system of claim 18, wherein the document provides hyperlinks for each of the plurality of patients, wherein each hyperlink, when selected, submits a request to the server for an additional document that details the reasons a given patient has been diagnosed with an HAI.
